(19) United States
(12) Patent Application Publication
(10) Pub. No.: US 2004/0095771 A1
(43) Pub. Date: May 20, 2004

(54) Reduced shadow system for illuminating an activity area

(75) Inventor: Lucas McDonald, Saint Paul, MN (US)

Correspondence Address: Larry M. Jennings, Larry M. Jennings, P.A., 1103 Monroe Street Northeast, Minneapolis, MN, 55413, US

(73) Assignee: Global Star Lighting, Inc.

(21) Appl. No.: 10/295,269

(22) Filed: Nov. 14, 2002

(51) Int. Cl. F21V 7/00; F21V 5/04

(52) U.S. Cl. 362/346; 362/298; 362/328; 362/307

(57) ABSTRACT

This lighting system improves the illumination of enclosed spaces by reducing undesirable shadows. Elongated curved reflective surfaces at the upper periphery of the illuminated space reflect light from a central source to the activity area. Light arriving at the activity area from many directions softens or eliminates shadows. Appropriate lighting contrast may be selected at installation and maintained by simple adjustments in response to changes in layout, furnishings, and activities conducted in the illuminated area. Contrast may be controlled as needed by varying the ratio of light reflected from the periphery to that proceeding directly from the central source to the activity area. A smaller number of efficient, powerful light sources lowers power consumption, reduces fixture installation and wiring costs, and diminishes maintenance labor compared to conventional lighting systems.

### TECHNICAL FIELD

This disclosure describes a system for illuminating areas, generally. Specifically, this disclosure is directed to articles for illuminating enclosed areas where people conduct activities. More specifically, lighting systems manufactured according to the teachings of the present disclosure provide even illumination of activity areas so as to reduce shadows. A particular embodiment can have a central source from which light travels to elongated, spaced-apart reflective surfaces that reflect light from the source to an activity area.

### BACKGROUND AND SUMMARY

Lighting of activity areas is essential because individuals spend so much time indoors. Although it is widely recognized that much human activity occurs indoors, we seldom notice that people in industrialized areas spend most of their time indoors. According to April, 1994 estimates published by the California Air Resources Board as Research Notes #94-6, children of all ages spend 8⁵% of their time indoors. In view of that fact, the importance of properly and efficiently lighting, or illuminating, enclosed spaces should readily be appreciated. Artificial light, may provide all illumination in some areas, buildings, or rooms, and may supplement daylight that enters through doors, skylights, lighting atria, and windows in others. Outdoor athletic fields, roads, parking areas, race tracks, buildings, are also provided with artificial lighting. Office, factory, warehouse, commercial, educational, dwelling, entertainment, and recreational facilities are among the many enclosed spaces that must be lighted in order for the occupants to carry out their selected activities. Suitable lighting is not always accomplished easily because many competing factors affect lighting choices. Among the considerations are installation cost, operating cost, maintenance cost, architecture, visual functionality, and esthetics. Each of these factors is affected by the type of activity that is to be illuminated. For the sake of simplicity, those activities will be summarized herein as “work” or “activity” but those terms are specifically intended to include all human activities that are conducted within areas illuminated partially or entirely by artificial light.

A building designed for one purpose may require modifications to the lighting system as the activities carried out in it change over time. For example, it may be difficult to use a video computer monitor in an office that has been equipped with a lighting system that was perfectly appropriate before that technology was introduced. In addition, the light flux required in a parking garage is far less than that needed to perform precision work such as engraving, electronics inspection, or surgery.

Not only must the amount of light supplied be appropriate for the activity, but the quality must also be appropriate, too. Harsh shadows may be created if light comes from a single point. Glare can result from light sources or reflections impinging on the eyes of a person or on objects within a person's visual field. Even if the amount of light is adequate, low contrast can make it difficult to see well enough to carry out desired activities. Light quality, or the spectral distribution of the electromagnetic radiation used for the particular lighting system must be appropriate for the activities, also. A low pressure sodium lamp that produces monochromatic yellow light, although very energy efficient, cannot be used to illuminate tasks that require accurate color rendition. Conventional tungsten light bulbs may be too reddish, or warm, for some activities, but quite appropriate for activities such as dining. Lamps may be selected with various color rendition indexes.

Lighting contrast may be controlled by appropriate source selection and positioning, but is affected by the structures and materials in the activity area. For example, fluorescent tubes are inherently somewhat diffuse. A person working on circuit boards might need a quartz-halogen spot light to enhance contrast even though an adequate general level of illumination has been provided by overhead fluorescent lamps.

Glare is irritating and reduces the performance of persons who are attempting to work or engage in other activities. Traditional methods for reducing glare include the installation of many light sources, providing indirect light that is reflected from surfaces such as ceilings or walls, providing task lighting that can be controlled by an individual, and providing diffusers between the observer and the light source. Each of these techniques is hampered by one or more drawbacks. Indirect light is often reflected from wall or ceiling surfaces having less than optimal reflectivity. Consequences of inefficient indirect lighting reflective surfaces include the need for additional fixtures, increased maintenance expense, and higher electrical power consumption than would be the case if light was directed toward the objects that are to be illuminated rather than the wall or ceiling.

Using multiple fixtures to avoid glare increases the cost of wiring the additional fixtures, additional maintenance costs for replacing additional lamps, higher costs for purchasing additional fixtures, and reduced lighting efficiency. By way of illustration, a 1000 watt General Electric LU1000 high pressure sodium lamp is rated at 126000 mean lumens which is 27% more light output than five 200 watt LU200 lamps having a mean output of 19,800 lumens. A 1000 watt lamp currently sells at approximately twice the price of a 200 watt lamp, and both lamps have the same rated life and color temperature. Although it is inefficient and more expensive to use the higher wattage lamp when a lower power one will work as well, it will often be possible to provide more efficient lighting by using fewer lamps that have greater light output. It has traditionally been difficult to utilize powerful, high efficacy sources to illuminate enclosed spaces because it has been difficult for architects and lighting designers to distribute the source output evenly; in general terms, the lower the ceiling, the more difficult it is to light an enclosed space evenly.

Previous lighting installations in warehouse, commercial, industrial, schools, and manufacturing facilities have relied on many lamps dispersed above the activity area to provide the evenness of illumination required for the comfort of the persons within the enclosed space who need to see in order to conduct their activities. In offices and light commercial spaces, fluorescent tubes are often used to light work areas. An inexpensive eight foot T12 60 watt fluorescent tube may produce 5060 lumens; in other words, 1000 watts used to operate a single high pressure sodium lamp will produce 50% more light than would 16.67 fluorescent tubes consuming the same amount of power.

However, the light must be provided in a way that does not irritate or cause people discomfort. If the only light source is a single lamp in the middle or a room, it is likely that shadows will be a problem for anyone who is not also near the center of the room. Objects that have been placed on shelving may be obscured by shadows, and uneven intensity of available light is likely to be very annoying as the distance from the source changes.

In order to reduce glare, the light source may be raised above the normal visual plane of the occupants of a room. If ceiling structural elements such as trusses, girders, joists, and mechanical duct work, wiring, and the like do not obstruct light, the technique can work well. Raising the light source can render the lighting more even if the reflectors are designed and constructed well. However, the problem of shadows is not cured by raising the light source. In addition, raising the light source often makes maintenance tasks such as inspecting, cleaning, and lamp replacement more time consuming and expensive.

In an effort to reduce shadows and excessive contrast, light fixtures have been designed that reflect light from the source toward ceilings, diffusers, and various shades or panels. Fluorescent tube lighting fixtures can have reasonable efficacy in terms of lumens per watt (lm/w), but typical systems require installation and wiring of many fixtures, or luminaires, because the intensity of light emitted from fluorescent tube sources is low compared to most other commercially available lamps. A conventional fluorescent tube having a length of eight feet might be limited to 60 watts with an efficacy of about 85 lm/w and although a very high output fluorescent tube might consume 215 watts the efficacy might be reduced to only 55 lm/w. Fluorescent tubes impose design limitations because they inherently produce diffuse light are elongated. Coiled or folded lamp tube configurations may offset the constraints, usually at a reduced efficacy and increased purchase price.

Luminaires used by dentists and surgeons are typical results of efforts to provide illumination in a manner that reduces the incidence of shadows. Many of these systems incorporate a high-intensity lamp source having much of its radiation directed toward integral reflective surfaces that can produce the effect of illumination arriving from all points on a plane rather than from a single point source. Unfortunately, such fixtures are seldom practical for industrial lighting due to their high initial expense and restricted coverage.

Another technique for reducing the incidence of shadows is to provide lighting that illuminates the activity area from many different directions by providing many luminaires that have overlapping coverage. In this way, the shadow cast by an object is softened by light radiating from additional sources of illumination. This technique achieves the desired result, but at considerable cost for installation, wiring, and maintenance of additional lighting fixtures and sources. When comparing sources of the same type, it is normally the case that higher wattage lamps have greater efficacy than do lower wattage units. Installation of high wattage, and hence higher efficacy, lighting sources may be constrained by the difficulty of providing system configurations that are sufficiently efficient to benefit from powerful sources. Since the amount of light reaching any point is inversely proportional to the square of the distance between the point and the source, sources that are more distant from the activity area will provide more even lighting distribution at the activity area, although it may be necessary to provide either additional sources or sources that have more sophisticated configurations of reflector, lens and source. Enclosed spaces that have limited ceiling height may be unable to benefit from the more powerful currently available sources because it has previously not been possible to obtain sufficiently uniform illumination.

However, an aspect of the present disclosure shows that a portion of the reflective surfaces of a lighting system can be spaced apart from the lamp, or source of illumination to obtain several advantages in suitable installations. These advantages can make it possible to use efficient light sources that reduce electrical power consumption yet still provide a system with lower lamp maintenance and wiring costs. It is possible to obtain those advantages with a system which illuminates an activity area with less shadow and glare than conventional lighting systems.

This disclosure shows a reduced shadow system for illuminating an activity area for being occupied by one or more persons, the activity area being above a floor and within a perimeter comprising a generally central light source that emits light in a multiplicity of directions, an upper reflective surface positioned above the light source, the upper reflective surface being shaped to reflect impinging light toward a direction including the floor, and a perimeter reflector spaced apart from the light source, the perimeter reflector being affixed to a structure enclosing the activity area and being further comprised of a curved reflective surface having a curve to reflect light emitted from the light source toward the activity area. In some embodiments, the perimeter reflector is further comprised of a generally horizontal elongated surface positioned above the floor and extending substantially along the perimeter of the activity area.

Reflective surfaces that are spaced apart from the lamp can have properties that differ from conventional light fixture reflectors. Because the reflective surfaces are positioned in a different location, it is possible to illuminate areas from additional directions and thereby reduce shadows. It may not be necessary or desirable in every system to have all light directed from the upper perimeter toward the activity area. Lighting that is too uniform may result in poor contrast and make perception difficult. When necessary, a portion of the light may be allowed to travel directly from the central source to the activity area rather than being reflected from the peripheral reflectors, also denominated perimeter reflector. Contrast may also be increased by providing daylight, supplemental overhead lighting, or supplemental task lighting.

Also, spaced apart reflective surfaces are not affected by heat emitted by the light source. Additional materials, substrates, coatings, treatments, fabrication techniques, and shapes can be used to manufacture the reflective surfaces shown in this disclosure that are simply not available for use with reflectors mounted close to a heat-emitting light source. It could be practical, for example, to apply an anti-static coating that is not durable at elevated temperatures as a surface treatment for spaced-apart peripheral reflectors.

Another effect made possible by separating the reflector from the lamp is that air circulation is different. Heated air circulating around lamps can cause deposition of dust on fixture components and reflectors that would otherwise not occur. For that reason, some spaced-apart reflector configurations will require cleaning less frequently than do conventional lighting fixtures.

Cleaning ordinary light fixtures is impaired by the presence of electrical wiring and fragile lamps. Cleanser and procedure choices are limited because risk of electrical shock and of lamp damage must be minimized. Spaced-apart reflectors, however, do not have electrical components that may become hazardous during cleaning or other maintenance.

The perimeter reflector may be constructed with appropriately curved surfaces, including flat surfaces, surfaces that are curved about one axis, surfaces that are curved about two axes, and surfaces that are curved in three axes. Curvatures may be concave, planar, convex, cylindrical, conical, spherical, elliptical, parabolic, hyperbolic, caternary, cycloidal, or other shapes adapted to provide desirable distribution of illumination in the activity area. Being separated laterally from the heat-emitting light source, the perimeter reflectors are subjected to neither the temperature peaks nor to the temperature cycling that must be tolerated by the reflective materials incorporated within fixtures proximate the lamp. The reflective surfaces may be prismatic, refractive, reflective on a first surface or a second surface, or incorporate any combination of such optical properties to yield suitably efficient reflector assemblies.

The term “activity area” denotes the area that is to be lighted by the reduced shadow lighting system. Examples of activity areas having substantial interest within the lighting industry and among property owners include work tables, work benches, floors, warehouse areas, work areas, factory floors, assembly lines, classrooms, gymnasia, laboratories, inspection areas, grading areas, sorting areas, etc. For convenience, all activities conducted in the illuminated, or lighted, area may be referred to as “work” although it is to be understood that the lighting system may be used in residential and recreational settings without departing from the scope of the invention or the claims. The lighting system disclosed is adapted for general illumination or background illumination such as that needed in warehouses or classrooms. The activity area that the lighting system of the present disclosure illuminates includes the three dimensional space in which the activities of the persons within the space are carried out and the term is used to make it clear that the system is intended to illuminate the subject matter of interest to the persons occupying the space and not merely the floor area, benches, or work tables.

Supplemental lighting for specific tasks (such as reading, soldering, sewing, etc.) would be provided as needed, as is the case with all prior lighting systems. It is believed that the present lighting system will reduce the need for supplemental task lighting by reducing shadows, thereby making it easier for persons to carry out tasks efficiently without the necessity of finding supplemental lighting.

Operation of the present lighting system yields many advantages when compared to previously known lighting systems. This lighting system is comprised of a high-efficiency source located near the center, or other convenient location, of a room so that a substantial portion of the visible radiation emitted is directed horizontally toward reflective members that are located at the perimeter of the area to be illuminated. The reflective members may be mounted generally vertically above the zone to be illuminated, for example, at the junction of ceiling with interior partition if those components are present. In warehouses, the reflective members may be suspended at other locations. A large room such as a warehouse may be subdivided into several areas so that unoccupied areas may be left unlit. In addition, it may be preferable to limit the size of illuminated areas to correspond with the modular layout of the building (e.g., a grid size of 20′×20′, 30′×30′, 40′×40′, 60′×60′, etc.). When used in residential structures, the grid size may be smaller or set to conform to the size of a room (e.g., 12′×12′). It can also be useful to make the illuminated area in a size that can be adequately lighted by a source, or lamp, that is readily available in a suitable wattage to provide the desired level of illumination for the activities that will be carried out in the illuminated activity zone. For example, a 1,000 watt, 126,000 lumen, high pressure sodium lamp in an 80% efficient fixture could provide 100 lux to an activity area of 1,000 m² (100 ft.×100 ft.), sufficient illumination for loading bays, raw material stores, and foyers. The same source could illuminate an area 60 ft.×60 ft. to about 300 lux, or a 40 ft.×40 ft. area to a level of 600 lux (typical of supermarkets, product testing, and sewing areas), or provide 1,200 lux to a 30 ft.×30 ft. area for jewelry work, clothing inspection, and other precision work. By way of comparison, outdoor daylight may be 80,000 lux on a sunny day or 10,000 lux under heavy overcast.

The reflective members may be flat or formed into concave, convex, or combined curves to provide the desired evenness of illumination in each installation. In some installations, it could be desirable to have the light source mounted near floor level with a beam aimed vertically upward toward an inverted conical or pyramidal reflector that aims the beam toward the perimeter reflective members. Such a configuration may simplify maintenance and installation.

### BRIEF DESCRIPTION OF THE DRAWINGS

FIG. 1 shows a side l elevation of an embodiment of the reduced shadow system for illuminating an activity area with sections through the source and perimeter reflectors.

FIG. 2 is a reflected ceiling view of the lighting system of FIG. 1 showing luminaires centered in modular grids of perimeter reflectors.

FIG. 3 shows sectional views alternative light source configurations for use in the lighting system of FIG. 1.

FIG. 4 is an alternative embodiment of the lighting system of FIG. 1 wherein a light source is situated below an elevated central reflector.

FIG. 5 shows an optional mounting configuration for installation of the perimeter reflectors of the lighting system of FIG. 1.

FIG. 6 is an alternative embodiment of the lighting system of FIG. 1 having an elevated central light source and a second light source situated below an elevated central reflector.

### DETAILED DESCRIPTION

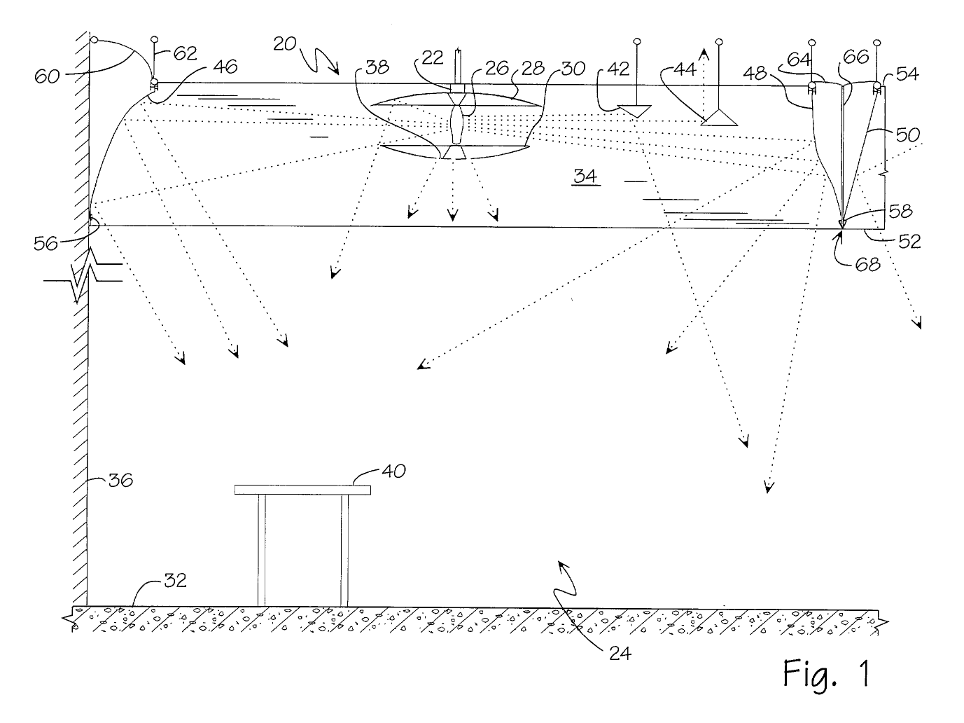

Turning now to the drawings, FIG. 1 shows an embodiment of a reduced shadow system for illuminating an activity area 20. This system for substantially reducing shadow and glare while providing even illumination levels within the designated area can be applied to an entire room or to modules (e.g. 40 ft.×40 ft.) within a large room or un-divided building such as a warehouse, barn, garage, or factory. A light source 22 of any type may be located near the center of the activity area 24 to be illuminated. The light source 22 may use an electrically powered lamp 26 such as a high pressure sodium or metal halide bulb. In other embodiments, the light source 22 could be made using a light pipe, optical fiber, arc lamp, flame, mantle, laser, light emitting diode, or other means for introducing natural or artificial light for illumination, each of which and their equivalents is deemed equivalent to an electrically powered lamp 26. The light source 22 is equipped with an upper reflector 28 and a lower reflector 30 designed to enhance radial light emission. Lenses or prisms may also be used either together with, or in place of the upper source reflector 28 and lower source reflector 30 to minimize losses and to confine light to the radial plane generally parallel to the floor 32 of the activity area 24.

It is also possible to configure the upper source reflector 28 and the lower source reflector 30, together with any lenses or prisms so that light emanating from the source describes a hollow conical pattern rather than a flat disk pattern. In that way, it would be possible to mount the source 22 at an elevation different from the elevation of the perimeter reflectors 34. Paths of light emanating from the source 22 are shown by dashed lines terminating with arrow points.

It is axiomatic that the angle of reflection from a flat reflecting surface or the tangent to a curved reflecting surface is the same as the angle of incidence under most circumstances. Any apparent deviation from the fundamental laws of physics and optics in the illustrated light paths is unintentional, and all assertions regarding the behavior of light and materials made in this disclosure are to be construed so as to conform with those physical and chemical laws published in the CRC handbook of Chemistry and Physics, 47^{th} Edition, and such other treatises as may have equivalent authority among engineers, physicists, and other professionals active in the fields of optics and lighting design.

The light source 22 is normally installed near the ceiling of the structure, but preferably below any roof trusses or other obstructions that would absorb light. Perimeter reflectors 34 are installed at or near the upper part of the walls 36, below structural elements, mechanical installations, and preferably near the elevation of the light source 22. The perimeter reflectors 34 may have a reflective face surface, a transparent face surface with a reflective backing, a coated reflective face surface, or may be made of one or more refractive elements such as prisms, and could be made from sheet stock having a multiplicity of prisms formed on one or more surfaces. Most of the light from the source 22 is focused on the perimeter reflectors 34. However, some of the light from the central source 22 may be directed downwardly through light transmitting portions 38 in the lower source reflector 30; the light transmitting portions may be apertures, slots, transparent materials, translucent materials, or any other light transmitting element. The amount of light directed downward from the source 22 may be varied by changing the relative sizes of the upper and lower source reflectors 28 30 or by positioning an auxiliary downward reflector 42 in the light path.

It is to be understood that some installations will benefit from the availability of light directed upward (e.g. to illuminate gantries), accordingly, the upper source reflector 28 may be fitted with light transmitting portions, the size of the upper source reflector 28 may be made smaller so as to permit light to reflect upward from the lower source reflector 30, or auxiliary upward reflectors 44 may be positioned in the light path between the source 22 and the perimeter reflectors 34. It is also possible to position auxiliary reflectors 42 44 to direct light to other selected locations.

Light from the source 22 striking the perimeter reflectors 34 is reflected to the activity area 24. In many installations, the perimeter reflectors 34 will be formed and adjusted to aim the maximum light possible onto a work surface such as a tabletop 40, storage shelves, or other objects to be illuminated within the activity area 24. The perimeter reflectors 34 may be mounted in any manner desired to accommodate any room or module configuration (e.g., rectangular, oval, round, hexagonal, square, triangular, pentagonal, etc.). Since most construction establishes square or rectangular activity areas 24, those terms may be used for convenience here, but without limitation or exclusion of activity areas having any other plan or elevation configuration.

An embodiment may be made with one or more concave perimeter reflectors 46. Convex or multiply curved perimeter reflectors 48 may also be used. Planar reflectors 50 might be used to direct light as desired in some embodiments of this system. Any combination of reflector shapes may be used in an installation to achieve optimum lighting performance.

The perimeter reflectors 34, in general will be elongated for being fitted at the upper and outer periphery of the activity area 24 to be illuminated. It will be possible to make the perimeter reflectors 34 from any reflective sheet, film, panel or other material. In a room 40 ft. square having a ceiling clearance of 16 feet, for example, aluminized Mylar® film 3.33 feet wide and 40 feet long could be installed by affixing the lower perimeter reflector edge 52 to the wall 14.27 feet above the floor and affixing the upper perimeter reflector edge to the ceiling 1.73 feet from the wall at the top of each wall or interior partition. Light emanating from the source 22 would travel to the perimeter reflector 34 and be reflected downward and inward toward the activity area. It will be possible to hold a reflective sheet or film at various convex curves by appropriate selection of the points on the wall and ceiling to which the lower perimeter reflector edge 52 and upper perimeter reflector edge 54 are attached.

If it is necessary to form a concave reflector section, reflective film may be attached to battens that can be flexed to the desired section curve and held with tension members such as wire, string, rope, banding, strips, webbing, rods, and other equivalent structures. Battens may be omitted if the reflector is fitted to any resilient sheet material that can be deformed in the desired manner. For example, a reflective metal sheet could be formed to the desired curve and then installed at the appropriate location. It would also be possible to hold a resilient metal sheet at the appropriate cross-section curve with tension members.

Alternatively, rigid, flexible, resilient, or semi-rigid pre-formed, reflector panels could be fabricated from metals, polymer resins, composites, flexible sheets, or other materials and ready for installation at the desired height to route light from the source 22 toward the activity area 24.

Lower perimeter reflector edges 52 may be attached to the wall directly by adhesives or fasteners 56, or by fitting the edge into a channel 58 that may be attached to the wall. A wall attachment member 60 may be used to link the upper perimeter reflector edge 54 to the wall 36 or a ceiling attachment member 62 can be used to link the perimeter reflector 34 to the ceiling, roof trusses, or other structural element available for mounting. Both the wall attachment member 60 and the ceiling attachment member 62 may be made adjustable to facilitate system layout, installation and setup.

A channel 58, tube, rod, reinforcement, or stiffener of any sort may be fitted to either edge of the perimeter reflector, if deemed beneficial. Perimeter reflectors may be mounted between support columns or in other modular room subdivisions in order to evenly light a room using more than a single source 22. A spreader 64 member may extend between the upper perimeter edge 54 and a riser 66 member which may be planar or be comprised of a multiplicity of discrete battens, shafts, rods, and their equivalents. The lower perimeter reflector edge 52, and the lower end or edge of the riser 66 can be connected within or by a channel 58, by fasteners, by adhesives, by sonic welding, heat sealing, or any other means.

The spreader 64 and riser 66 may be connected by any convenient type of fastener, or may be formed integrally. It may be possible also to form the spreader 64, riser 66, and reflector 34 integrally or as an assembly ready for hanging. For example, coiled reflective stock could be formed into perimeter reflectors 34 of any desired length using a forming apparatus similar, or identical, to the machines used to form continuous steel siding. In the case of assembled or integrally formed back-to-back perimeter reflector 68 elements having sufficient stiffness, it may be possible to omit either the spreader 64 or the riser 66 or both. Back-to-back perimeter reflectors 68 may be suspended from ceiling attachment members 62 that are affixed to preexisting components of the structure, such as roof trusses. If necessary, suitable struts, tubes, rods, pipes, beams, or other members may be added to the structure to enable the ceiling attachment members 62 to be attached so as to make it convenient to suspend the perimeter reflectors. Perimeter reflectors may be made of materials light enough to be installed in a manner similar to that used to install suspended acoustical tile grid.

It will be possible for skilled electrical contractors to properly install the light source 22 at the desired location and height without undue effort. The type and wattage of the lamp 26 may be determined based on the activities contemplated, the area to be illuminated, the room factor, and the ceiling height. It is to be understood that certain types of lamp 26 may yield different operating characteristics that others. For example, lamps may be equipped with internal or external reflectors to enhance the emission of light radially. Other lamps 26 may be available only in shapes that are incompatible with embodiments according to this specification. It is believed, however that high efficiency metal halide, high pressure sodium and other lamps 26 are available in configurations suitable for practicing the invention.

The width of the perimeter reflector 34 may be affected by several factors. If the light emanating from the source 22 is focused in a thin disk or layer having little divergence between the source 22 and the perimeter reflector 34 (i.e., radially collimated), the perimeter reflector 34 can be narrow. If light from the source diverges substantially, the perimeter reflector 34 will be more effective if it is wide enough to redirect the largest practical portion of the source beam toward the activity area 24.

Likewise, if light from the source is divergent, it might be preferred to install a concave perimeter reflector 46 to focus the light onto the activity area 24 at the height above the floor 32 where most of the activities to be illuminated occur. On the other hand, if the source 22 projects a narrow beam, it may be desirable to use a narrow, convex perimeter reflector 48 to disperse light more evenly into the activity area. It might also be practical to use highly reflective, non-imaging, (e.g., white) planar or curved perimeter reflector panels 50 to direct light from the source 22 to the activity area 24 in some installations (e.g., where a substantial amount of upward light is desired). It should be noted that various tints, colors, coverings, coatings, or materials for fabrication may be incorporated in the manufacture of perimeter reflectors to achieve desired lighting effects in applications where maximum lighting efficacy is not essential.

It should also be noted that embodiments are particularly suited to improving illumination of large areas that have limited ceiling clearance by reducing shadows and by reducing variations in light intensity within an illuminated activity area 24. Embodiments may also be installed for illuminating only the specific vertical segment in which the activity area is present. It may be possible to direct much of the source 22 output to the surface of a work table 40 or to elevated work areas.

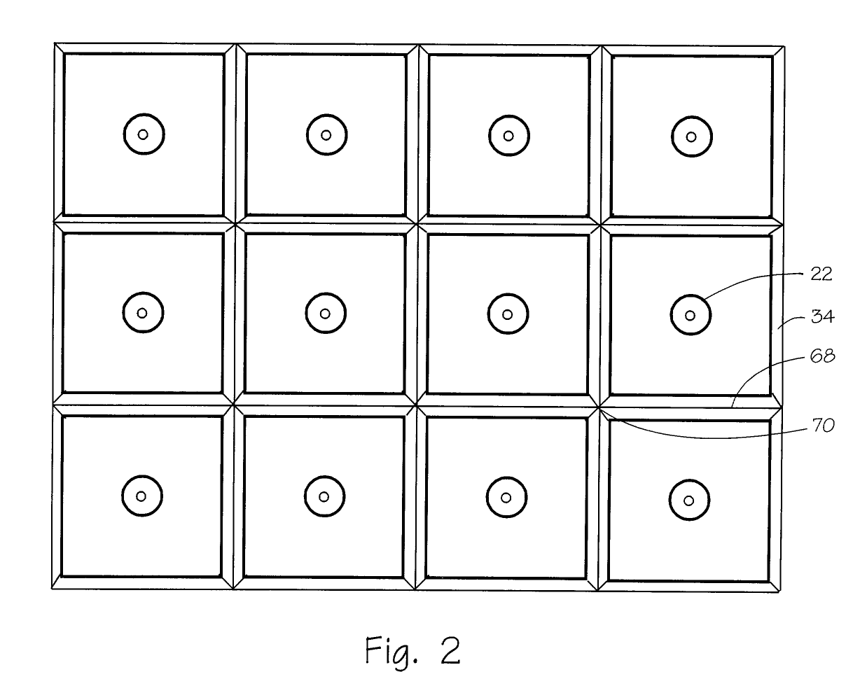

FIG. 2 is a reflected ceiling view of the lighting system of FIG. 1 showing luminaires, or light sources 22 centered in modular grids of perimeter reflectors 34. If the individual modules depicted were 40 ft.×40 ft. the figure would show the lighting installation for a 120 ft.×160 ft. space (19,200 ft²). Support columns 70 might be required at six locations within the structure to support the roof, ceiling, or other floors of a multi-story structure.

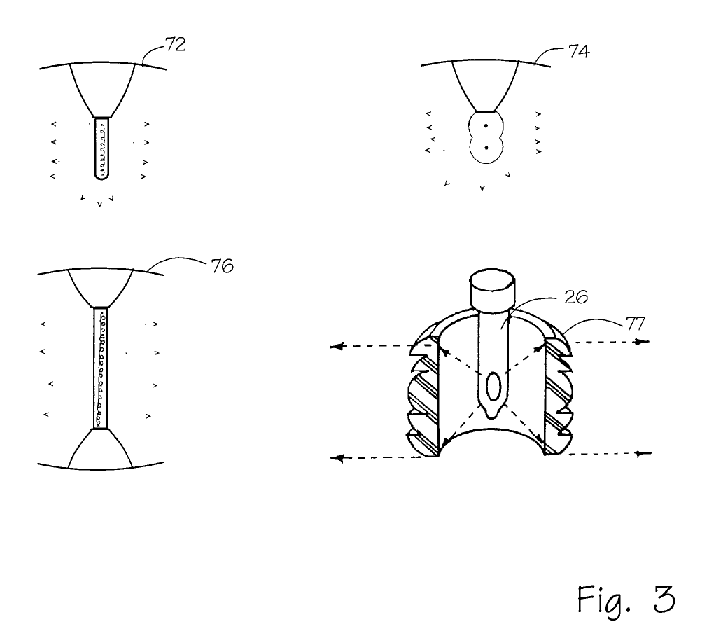

FIG. 3 depicts several types of light sources 22, or luminaires that may comprise elements of embodiments according to this disclosure. Embodiments may incorporate a luminaire adapted for elongated lamps 72 that emit most light radially. Lenses or condensers may be included in a luminaire 74 to produce radially collimated light. A dual reflector luminaire 76 may accommodate an elongated, radially emitting lamp or other lamp types.

Also shown in FIG. 3 is a lens 77 adapted for focusing or collimating the light emitted from the lamp 26 radially. Although the lens 77 depicted is an annular lens with prism elements, it is to be understood that linear elements, Fresnel lenses, or other lens types could perform similarly. It is to be understood also that more than one annular lens, or a single annular lens having multiple focusing elements, may be positioned to surround an elongated lamp 26 such as the one shown in the luminaire 76 in order to refract light emitted from the lamp 26 toward the perimeter reflectors 34.

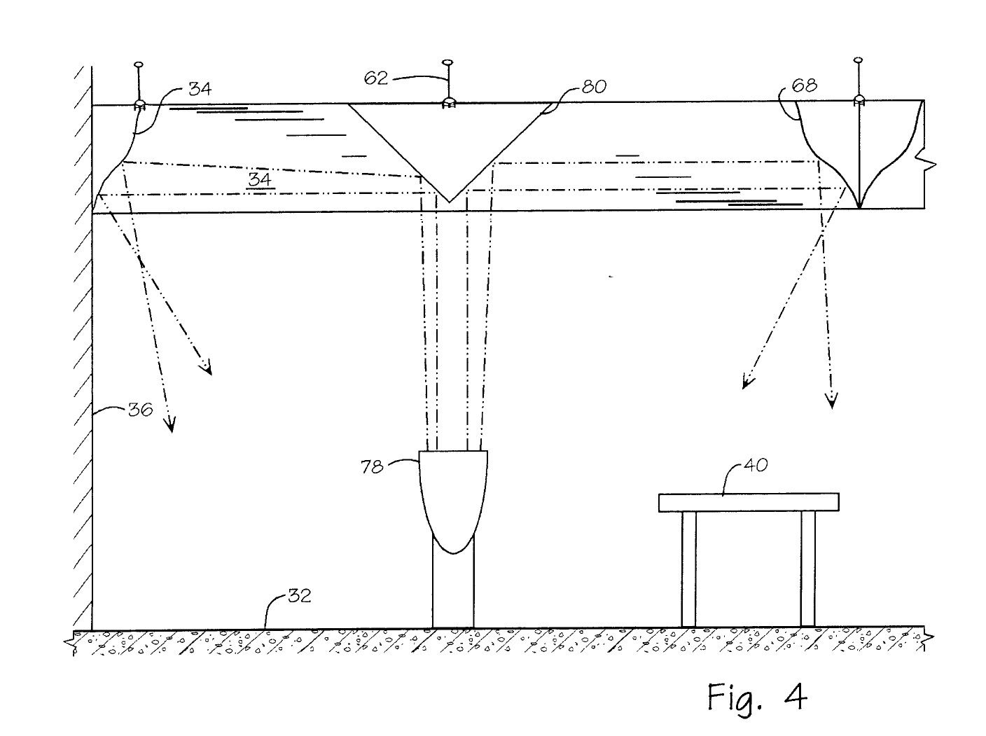

FIG. 4 is an alternative embodiment of the lighting system of FIG. 1 wherein a narrow beam light source having a lamp 78 is situated below an elevated pyramidal or conical central dispersion reflector 80. It is to be understood that such a narrow beam source 78 may equivalently be mounted above the pyramidal or conical central dispersion reflector 80, and that in such a configuration, the central reflector 80 would be inverted from the depiction of FIG. 4. This embodiment may be preferred for temporary installations, when an existing narrow beam or cylindrically collimated light source is available at the site of system 20 installation, or when multiple lamps 26 are to be operated simultaneously to provide greater light intensity, to obtain desired color balance, or for any other purpose.

In this manner, lighting efficacy could conveniently be increased by combining lamps of differing types. It would be possible, for example, to fit a light source 22 with a low pressure sodium lamp which, although very efficient, produces monochromatic light that many people find objectionable. A narrow beam source 78 of a different type, such as metal halide, could be distributed by a pyramidal or conical central dispersion reflector 80 to add light from other portions of the visible spectrum to improve color balance with superior performance in terms of lumens per watt.

It may also be possible to provide multiple types of lamps 26 within a single source or luminaire 22, from each of which light emanates radially toward the perimeter reflectors 34. Lamps 26 may be fitted with internal or external reflector elements, lenses, prisms, or other components that will enhance radially or conically directed light emission, and lead to further improvements to the utility of embodiments according to this specification.

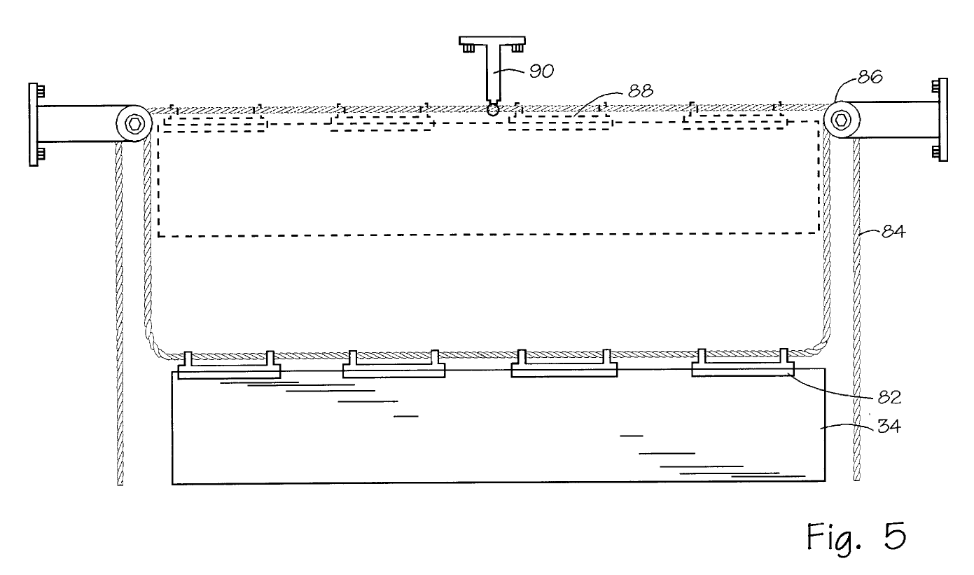

FIG. 5 shows an optional mounting configuration for installation of the perimeter reflectors of the lighting system of FIG. 1. Clips 82 or other linking components of any known structure affixed to the upper perimeter reflector edge 54 may engage a rope, bar, cable, wire, elongated member, or other support 84. The support member 84 may be attached to trusses, joists, walls, ceilings, other building components, or structures by rollers, sheaves, eyes, or other suitable fasteners 86 installed near the ends of the perimeter reflector 34. This configuration allows the perimeter reflector 34, or sections of it, to be lowered and raised for cleaning, maintenance, and adjustment.

Although the perimeter reflector 34 is shown in a state ready for installation, the final location 88 of the installed perimeter reflector is shown by dashed lines. A central support 90 may engage the support member 84 to retain the perimeter reflector at the desired position.

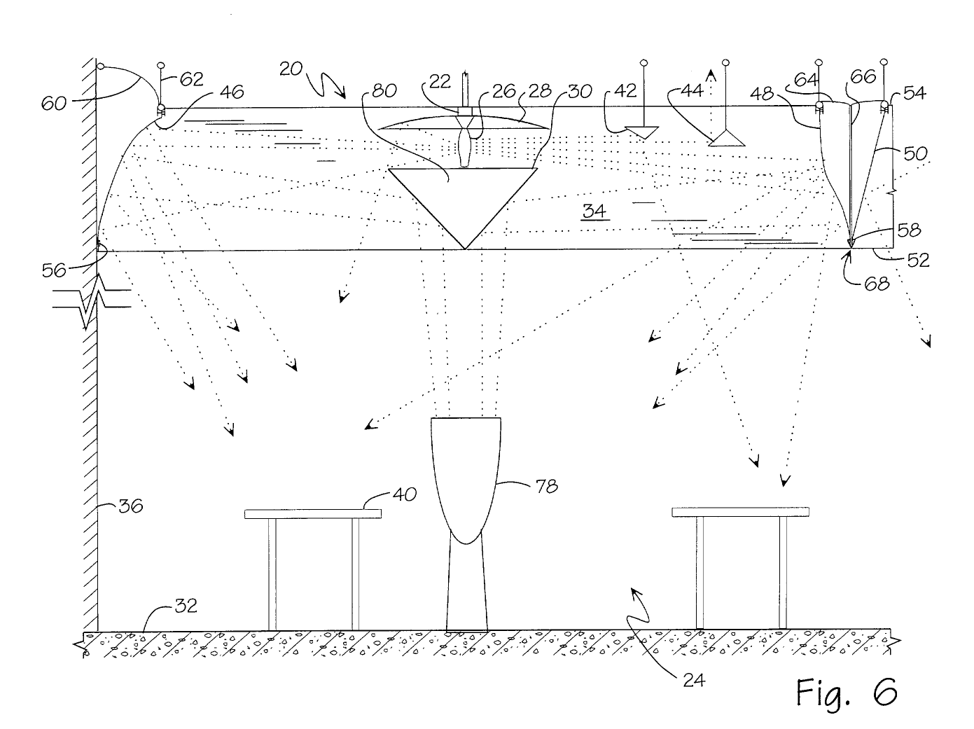

FIG. 6 is an alternative embodiment of the lighting system of FIG. 1 having an elevated central light source and a second light source situated below an elevated central reflector. This alternative embodiment is comprised of a luminaire 22 fitted with a lamp 26, an upper source reflector 28, a lower source reflector 30 that, in combination, direct light toward the perimeter reflectors 34, and a reflective inverted dispersion pyramid or cone 80 positioned below the lower reflector 30. The dispersion cone or pyramid 80 may be attached to, or formed integrally with, the upper luminaire 22. In addition, a second narrow beam light source 78 such as a spotlight or axially collimating luminaire may be positioned below the upper luminaire. The second source may be mounted at a convenient location on the floor, atop installed shelving, or at any other desired location. The dispersion pyramid or cone 80 may be deformed somewhat to compensate for a non-vertical beam where the narrow beam light source 78 is not installed directly below the center of the upper luminaire 22. It is to be understood that the dispersion cone 80 could also be positioned above the radial emitting luminaire 22 equivalently, or both above and below the radially emitting luminaire 22.

Advantages available from this configuration may include the ability to control the light level supplied to an activity area 24 in two or three steps, ability to use lamps that are impractical or impossible to fit with dimmers, increased light output, ability to use more than one type of lamp at the same time (e.g., low pressure sodium and metal halide lamps could be used simultaneously to yield higher efficiency with acceptable color balance), increased amount of light available at the desired places within the activity area 24, redundancy to avoid blackout upon cessation of light output by a source, improved access for maintenance, and less heat buildup.

FIG. 6 discloses an alternative reduced shadow system 20 for illuminating an activity 24 area for being occupied by one or more persons, the activity area 24 being above a floor 32 and within a perimeter, comprising: a central light source 22 that emits light radially and generally parallel to the floor 32,

an upper reflective surface 28 positioned above a lamp 26 the upper reflective surface 28 being shaped to direct light emitted by the lamp radially, a lower reflective surface 30 positioned below the lamp 26, the lower reflective surface 30 being shaped to direct light emitted by the lamp 26 radially toward a perimeter reflector 34 spaced apart from the light source 22, the perimeter reflector 34 being affixed to a structure enclosing the activity area and being further comprised of a curved reflective surface having a curve to reflect light emitted from the light source 22 toward the activity area 24, a narrow beam upward source 78 positioned below the central light source 22, and a dispersion reflector positioned 80 below the central light source 22.

The lighting system may be configured so that the perimeter reflector 34 is further comprised of a generally horizontal elongated surface positioned above the floor 32 and extending substantially along the perimeter of the activity area 24. It is also possible to make the lighting system 20 with flexible material so that the curvature of the elongated perimeter reflector 34 reflective surface may be varied to achieve desired distribution of light within the activity area 24 or with the lamps 26 of the central source 22 and the upward source 78 are separately controllable so that the color balance and illumination intensity may be set at desired levels. The foregoing embodiments have been proposed and described as examples only, and are not to be construed as limitations of the invention. Changes and modifications in the specifically described embodiments may be carried out without departing from the scope of the invention which is intended to be limited only by the scope of the appended claims. It is further to be understood that elements recited in the following claims are intended and deemed to include their structural and functional equivalents.

DRAWING REFERENCE NUMBERS

| | |
|---|---|
| 20 | reduced shadow system for |
| | illuminating an activity area |
| 22 | light source, or luminaire |
| 24 | activity area |
| 26 | electrically powered lamp |
| 28 | upper source reflector |
| 30 | lower source reflector |
| 32 | floor |
| 34 | perimeter reflectors, in general |
| 36 | wall |
| 38 | lower source reflector light |
| | transmitting portions |
| 40 | tabletop |
| 42 | auxiliary down reflector |
| 44 | auxiliary up reflector |
| 46 | concave perimeter reflector |
| 48 | convex perimeter reflector |
| 50 | planar perimeter reflector |
| 52 | lower perimeter reflector edge |
| 54 | upper perimeter reflector edge |
| 56 | fastener |
| 58 | channel |
| 60 | wall attachment member |
| 62 | ceiling attachment member |
| 64 | spreader |
| 66 | riser |
| 68 | back-to-back perimeter |
| | reflectors |
| 70 | roof truss support column |
| | location |
| 72 | luminaire adapted for elongated |
| | lamps |
| 74 | collimating luminaire with lens |
| 76 | dual reflector luminaire |
| 77 | lens, annular with prism |
| | elements |
| 78 | narrow beam upward source |
| | having a lamp |
| 80 | dispersion reflector pyramidal |
| | or conical |
| 82 | clip |
| 84 | elongated support member |
| 86 | eye, sheave, or roller |
| 88 | location of installed perimeter |
| | reflector |
| 90 | central support member |

What is claimed is:

1. A lighting system comprising:
a generally central light source that emits light in a multiplicity of directions,
an upper reflective surface positioned above the light source, the upper reflective surface being shaped to reflect impinging light toward a direction including the floor, and
a perimeter reflector spaced apart from the light source, the perimeter reflector being affixed to a structure enclosing the activity area and being further comprised of a curved reflective surface having a curve to reflect light emitted from the light source toward the activity area.

2. The lighting system defined in claim 1 wherein the perimeter reflector is further comprised of a generally horizontal elongated surface positioned above the floor and extending substantially along the perimeter of the activity area.

3. The lighting system defined in claim 2 wherein the curvature of the elongated perimeter reflector reflective surface may be varied to achieve desired distribution of light within the activity area.

4. The lighting system defined in claim 3 wherein the central light source is further comprised of a lower source reflector having variable light transmitting elements through which light may radiate downward toward the activity area.

5. The lighting system defined in claim 4 being further comprised of a means for raising and lowering the perimeter reflector for cleaning, maintenance, and adjustment.

6. The lighting system defined in claim 5 wherein the light source is further comprised of a lens element that directs light from the lamp toward the perimeter reflector.

7. The lighting system defined in claim 6 wherein the lens element is an annular lens disposed around the lamp so as to refract light toward the perimeter reflector.

8. A reduced shadow system for illuminating an activity area for being occupied by one or more persons, the activity area being above a floor and within a perimeter, comprising:
a central light source that emits light radially and generally parallel to the floor,
an upper reflective surface positioned above the light source, the upper reflective surface being shaped to direct light emitted by a lamp radially in the direction of,
a perimeter reflector spaced apart from the light source, the perimeter reflector being affixed to a structure enclosing the activity area and being further comprised of a curved reflective surface having a curve to reflect light emitted from the light source toward the activity area.

9. The lighting system defined in claim 8 wherein the central light source is further comprised of a lower source reflector.

10. The lighting system defined in claim 9 wherein the lower source reflector is further comprised of apertures that transmit light from the lamp downward toward the activity area.

11. The lighting system defined in claim 10 being further comprised of at least one lens positioned to focus light from the lamp onto the perimeter reflector.

12. The lighting system defined in claim 11 wherein the lens is located between the upper source reflector and the lower source reflector.

13. The lighting system defined in claim 8 wherein the perimeter reflector portions form a polygon having sides of equal length.

14. The lighting system defined in claim 8 wherein the central light source including the lamp, the upper reflector, and lower reflector are replaced by a dispersion reflector and a narrow beam upward source disposed having a lamp below the dispersion reflector.

15. The lighting system defined in claim 8 wherein the perimeter reflector is formed as a circle having the light source proximate the center of the circular perimeter reflector.

16. A reduced shadow system for illuminating an activity area for being occupied by one or more persons, the activity area being above a floor and within a perimeter, comprising:
a central light source that emits light radially and generally parallel to the floor,
an upper reflective surface positioned above a lamp, the upper reflective surface being shaped to direct light emitted by the lamp radially,
a lower reflective surface positioned below the lamp, the lower reflective surface being shaped to direct light emitted by the lamp radially toward,
a perimeter reflector spaced apart from the light source, the perimeter reflector being affixed to a structure enclosing the activity area and being further comprised of a curved reflective surface having a curve to reflect light emitted from the light source toward the activity area,
a narrow beam upward source positioned below the central light source, and
a dispersion reflector positioned below the central light source.

17. The lighting system defined in claim 16 wherein the perimeter reflector is further comprised of a generally horizontal elongated surface positioned above the floor and extending substantially along the perimeter of the activity area.

18. The lighting system defined in claim 17 wherein the curvature of the elongated perimeter reflector reflective surface may be varied to achieve desired distribution of light within the activity area.

19. The lighting system defined in claim 16 wherein the curvature of the elongated perimeter reflector reflective surface may be varied to achieve desired distribution of light within the activity area.

20. The lighting system defined in claim 16 wherein the central source lamp and the upward source lamp are separately controllable.
